(19) United States
(12) Patent Application Publication
(10) Pub. No.: US 2013/0340508 A1
(43) Pub. Date: Dec. 26, 2013

(54) MOBILE PHASE DELIVERY DEVICE AND LIQUID CHROMATOGRAPH

(71) Applicant: SHIMADZU CORPORATION, Kyoto (JP)

(72) Inventor: Yusuke Osaka, Kyoto (JP)

(21) Appl. No.: 13/903,145

(22) Filed: May 28, 2013

(30) Foreign Application Priority Data
Jun. 21, 2012 (JP) 2012-139874

(51) Int. Cl. G01N 30/46; B01F 15/02

(52) U.S. Cl. CPC G01N 30/468; B01F 15/0243
USPC 73/61.53; 366/182.2

(57) ABSTRACT

A mobile phase supply device comprises an aqueous path including a first delivery pump for delivering an aqueous mobile phase, an organic solvent path including a second delivery pump for delivering an organic solvent mobile phase, and a mixer for mixing mobile phases from the aqueous path and the organic solvent path, and supplying the mixture to an analysis path of a liquid chromatograph. A flow resistance between the second delivery pump and the mixer is greater than a flow resistance between the first delivery pump and the mixer.

### BACKGROUND OF THE INVENTION

1. Field of the Invention

The present invention relates to a mobile phase delivery device for supplying a mixed solution of an aqueous mobile phase and an organic solvent mobile phase to an analysis path while changing the composition over time, and a liquid chromatograph provided with the mobile phase delivery device.

2. Description of Background Technique

As a liquid chromatograph, a gradient liquid chromatograph that is provided with an analytical column and a detector, and that performs separation analysis on a sample while changing over time the composition of a mobile phase flowing through an analysis path is known(see U.S. 2007-0144977 A1). A mobile phase that flows through an analysis path is generally a mixed solution of an aqueous mobile phase and an organic solvent mobile phase, and the mixing ratio is changed by adjusting the delivery flow rate of delivery pumps delivering the mobile phases.

An example of a conventional gradient liquid chromatograph will be described with reference to FIG. 5.

An upstream analysis path 2a and a downstream analysis path 2b are provided as analysis paths for performing separation analysis on a sample. An analytical column 8 for separating a sample, and a detector 10 for detecting a sample component separated by the analytical column 8 are provided along the downstream analysis path 2b. One end of the upstream analysis path 2a is connected to a mixer 50. An aqueous path 42 for delivering an aqueous mobile phase by a delivery pump 46, and an organic solvent path 44 for delivering an organic solvent mobile phase by a delivery pump 48 are connected to the mixer 50, the aqueous mobile phase and the organic solvent mobile phase are mixed by the mixer 50, and the mixed solution is supplied to the upstream analysis path 2a.

The other end of the upstream analysis path 2a and one end of the downstream analysis path 2b are each connected to one port of a switching valve 30 of a sample introduction unit 6. The sample introduction unit 6 includes a switching valve 30, a sample delivery path 32, a drain path 34, and a trap path 36. The sample delivery path 32 is a path for delivering a solution containing a sample by a delivery pump 33. The trap path 36 includes a trap column 40, and is capable of temporarily storing a sample delivered by the sample delivery path 32 in the trap column 40.

One end of the sample delivery path 32 and of an outlet path 34, and both ends of the trap path 36 are connected to ports of the switching valve 30. The switching valve 30 is for switching connection between adjacent ports, and switching between a state where the trap path 36 is connected between the sample delivery path 32 and the drain path 34 (a trap mode) and a state where the trap path 36 is connected between the upstream analysis path 2a and the downstream analysis path 2b (an injection mode) is enabled by the switching by the switching valve 30. In the trap mode, the upstream analysis path 2a and the downstream analysis path 2b are directly connected, and in the injection mode, the sample delivery path 32 and the drain path 34 are directly connected.

In the trap mode, a solution containing a sample is delivered from the sample delivery path 32, and the sample is trapped in the trap column 40. Then, switching to the injection mode is performed to thereby deliver a mobile phase solvent from the upstream analysis path 2a, and the sample trapped in the trap column 40 is introduced into the downstream analysis path 2b together with the solvent.

Pressure exerted on the delivery pumps 46 and 48 may suddenly and drastically change at the time of switching from the trap mode to the injection mode by the switching by the switching valve 30 in the manner described above. If pressure is changed suddenly and drastically during delivery of the aqueous mobile phase and the organic solvent mobile phase, the balance of delivery between the aqueous mobile phase and the organic solvent mobile phase may become lost, and the organic solvent mobile phase that is less viscous than the aqueous mobile phase and that flows more easily may be instantaneously delivered at a high flow rate. If the organic solvent mobile phase is delivered at a high flow rate when the trap mode is switched to the injection mode, a sample may pass through without being separated by the analytical column 8.

Further, with a nano-flow LC (liquid chromatograph) system where the flow rate of a mobile phase flowing through the downstream analysis path 2b is in units of nL, the mobile phases delivered by the delivery pumps 46 and 48 are split and delivered. According to such a nano-flow LC system, in the case of the pressure inside the trap path 36 in the trap mode being lower than the pressure on the delivery pumps 46 and 48, if the switching valve 30 is switched from the trap mode to the injection mode, the pressure on the delivery pumps 46 and 48 is suddenly and drastically reduced, and the balance of delivery or the split ratio of the aqueous mobile phase and the organic solvent mobile phase is disturbed, and the delivery flow rate of mobile phase is greatly disturbed.

FIGS. 4(A) and 4(B) are graphs showing change over time of detected signals of a detector, and FIG. 4(A) shows a case where there is no reduction in the pressure on the delivery pump for delivering the organic solvent mobile phase at the time of switching from the trap mode to the injection mode (for example, trap column pressure of 6.5 MPa, and analytical column pressure of 5 MPa), and FIG. 4(B) shows a case where there is a reduction in the pressure on the delivery pump for delivering the organic solvent mobile phase at the time of switching from the trap mode to the injection mode (for example, trap column pressure of 2.0 MPa, and analytical column pressure of 5 MPa). The peak in FIG. (B) shown with a dotted-line circle is due to instantaneous delivery at a high flow rate of the organic solvent mobile phase caused by a change in the pressure at the time of switching from the trap mode to the injection mode which then results in a sample in the trap column passing through the analytical column without being trapped. In this manner, when a greater amount of organic solvent mobile phase than aqueous mobile phase is delivered at the start of analysis of a sample, the sample flows out without being separated by the analytical column.

On another note, resistance tubes having approximately the same flow resistance are conventionally connected near mixers on the upstream side for each of the aqueous path and the organic solvent path. Mutual interference between a delivery pump for delivering the aqueous mobile phase and a delivery pump for delivering the organic solvent mobile phase may thereby be prevented, and the delivery flow rate of mobile phase may be stabilized. Stabilization of the delivery flow rate is based on a premise that the pressure on each delivery pump is not suddenly and drastically changed. If the pressure is changed gradually, the flow rate of the delivery pump is changed accordingly but the change is gradual, and the pressure on the delivery pump is at the end stabilized and the delivery flow rate is stabilized. However, if the pressure is suddenly and drastically changed by an external cause in the manner described above, the balance of delivery of the aqueous mobile phase and the organic solvent mobile phase is lost, and instantaneous flow at a high flow rate of a low-viscosity organic solvent mobile phase cannot be prevented.

### SUMMARY OF THE INVENTION

Accordingly, the present invention aims to suppress a change in the delivery flow rate of a mobile phase due to a change in the pressure at the time of switching the switching valve from the trap mode to the injection mode, and to prevent a problem of a sample passing through without being separated by the analytical column.

A mobile phase supply device according to the present invention includes an aqueous path including a first delivery pump for delivering an aqueous mobile phase, an organic solvent path including a second delivery pump for delivering an organic solvent mobile phase, and a mixer for mixing mobile phases from the aqueous path and the organic solvent path and supplying the mixture to an analysis path of a liquid chromatograph wherein a flow resistance between the second delivery pump and the mixer is greater than a flow resistance between the first delivery pump and the mixer.

At this time, it is conceivable to suppress a change in the delivery flow rate by making the flow resistances of both the aqueous path and the organic solvent path great. However, with a high-pressure liquid chromatograph, a high pressure has to be applied to an analytical column, and thus, it is difficult to increase the flow resistance of the mobile phase supply device from the viewpoint of relationship to the performance of a delivery pump.

The sizes of the flow resistance of the aqueous path and the flow resistance of the organic solvent path are set to appropriate values based on the relationship between a delivery pressure necessary for the analytical column and the performance of the delivery pump.

A liquid chromatograph according to the present invention includes an analysis path including an analytical column for separating a sample, and a detector for detecting a sample component separated by the analytical column, the mobile phase supply device according to the present invention, being connected to an upstream end of the analysis path and being, for supplying to the analysis path, a mobile phase solvent of a mixed solution of an aqueous mobile phase and an organic solvent mobile phase, and a sample introduction unit including a sample delivery path for delivering a solution containing a sample, a trap column for temporarily storing the sample, and a switching valve for switching a path to be connected, the sample introduction unit being capable of switching, by switching of the switching valve, to either of a trap mode where the trap column is connected to a downstream side of the sample delivery path and an injection mode where the trap column is connected between the mobile phase supply device and an analytical column.

According to the mobile phase supply device of the present invention, the flow resistance between the second delivery pump of the organic solvent path and the mixer is greater than the flow resistance between the first delivery pump and the mixer, and even if the pressure on the first delivery pump and the second delivery pump is instantaneously changed according to an external cause, instantaneous flow at a high flow rate of the organic solvent mobile phase, which is less viscous than the aqueous mobile phase, may be prevented.

According to the liquid chromatograph of the present invention, since the mobile phase delivery device of the present invention is provided, a sudden and drastic increase in the flow rate of the organic solvent mobile phase, which is less viscous than the aqueous mobile phase, due to an instantaneous change in the pressure at the time of the sample introduction unit being switched from the trap mode to the injection mode may be suppressed. Accordingly, a case where a sample passes through without being separated by the analytical column because of the organic solvent mobile phase being delivered at a high flow rate may be prevented.

### BRIEF DESCRIPTION OF THE DRAWINGS

FIG. 1 is a path diagram schematically showing an example of a liquid chromatograph.

FIGS. 2A and 2B are path diagrams for describing a structure of a sample introduction unit of the embodiment.

FIG. 3 is a graph showing change over time of a flow rate of an organic solvent mobile phase for a case where a flow resistance of a second resistance tube is greater than a flow resistance of a first resistance tube, and a case where this is not so.

FIGS. 4A and 4B are graphs showing change over time of detected signals of a detector, and FIG. 4A shows a case where there is no reduction in the pressure on a delivery pump for delivering an organic solvent mobile phase at the time of switching from a trap mode to an injection mode, and FIG. 4B shows a case where there is a reduction in the pressure on the delivery pump for delivering the organic solvent mobile phase at the time of switching from the trap mode to the injection mode.

FIG. 5 is a path diagram schematically showing an example of a conventional liquid chromatograph.

### DETAILED DESCRIPTION OF THE INVENTION

According to an embodiment of a mobile phase supply device of the present invention, by applying a split type where an aqueous path is split at a downstream side of a first delivery pump into a path joined to a mixer and a first split path different from the path, and where an organic solvent path is split at a downstream side of a second delivery pump into a path joined to the mixer and a second split path different from the path, instantaneous delivery at a high flow rate of an organic solvent mobile phase may be suppressed, and a sample may be prevented from passing through without being separated by an analytical column, even when the split ratio of each of the aqueous path and the organic solvent path is disturbed due to a change in the pressure at the time of switching from a trap mode to an injection mode.

In another embodiment, the path, of the organic solvent path, joined to the mixer includes a path whose inner diameter is smaller than that of the path, of the aqueous path, joined to the mixer so that the flow resistance of the organic solvent path is greater than the flow resistance of the aqueous path.

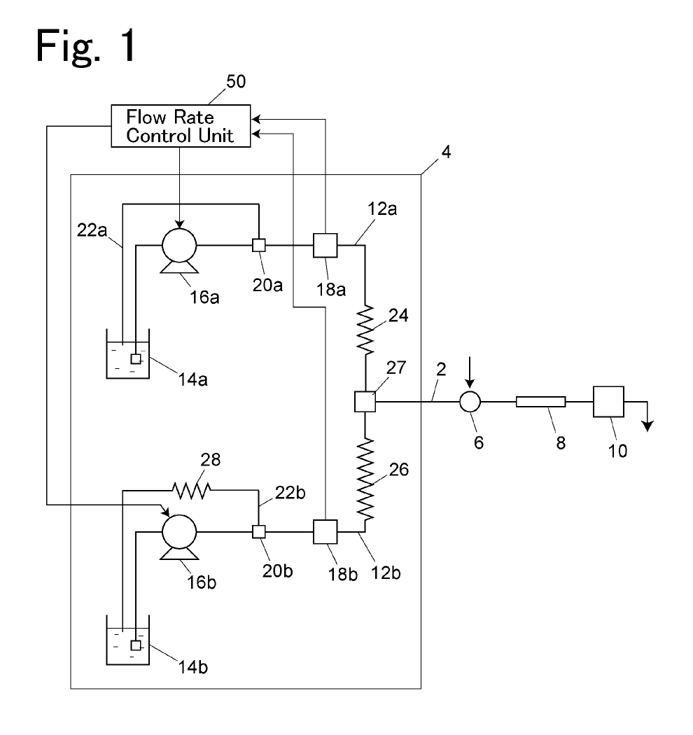

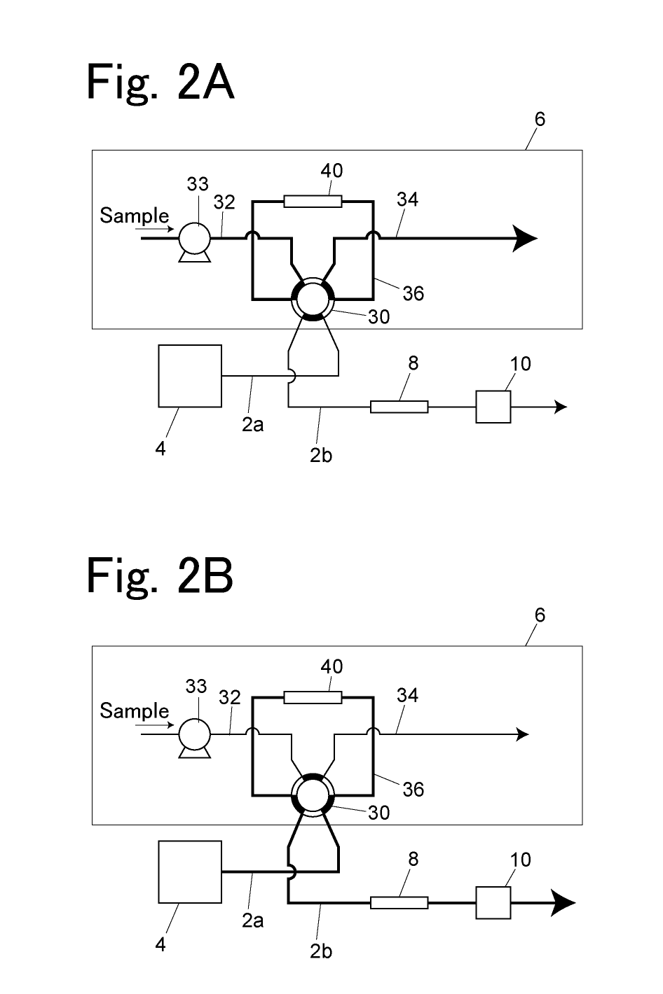

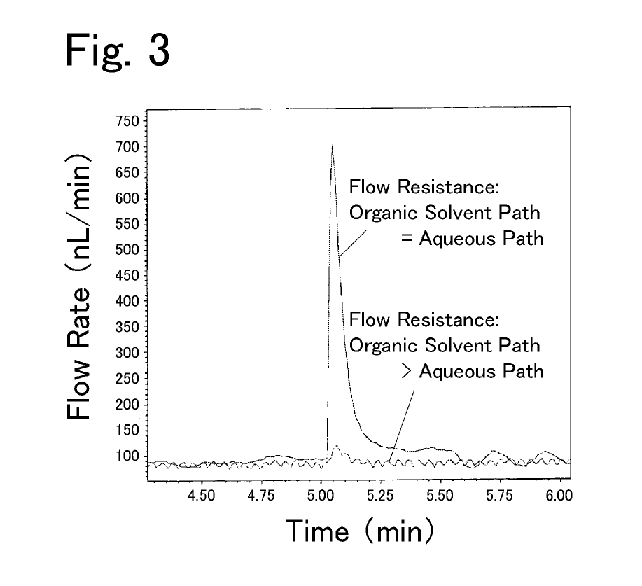

An example of a liquid chromatograph will be described with reference to FIGS. 1 and 2.

As shown in FIG. 1, this liquid chromatograph has a mobile phase supply device 4 connected to an upstream end of an analysis path 2, and a sample introduction unit 6, an analytical column 8, and a detector 10 are provided in this order along the analysis path 2 from the upstream. As shown in FIGS. 2(A) and 2(B), the analysis path 2 is formed from an upstream analysis path 2a and a downstream analysis path 2b, and the downstream end of the upstream analysis path 2a and the upstream end of the downstream analysis path 2b are each connected to one port of a switching valve 30 of the sample introduction unit 6. The analytical column 8 and the detector 10 are provided along the downstream analysis path 2b.

The sample introduction unit 6 is configured to be capable of switching, by the switching of the switching valve 30, between a trap mode of trapping a sample in a trap column 40 (see FIG. 2(A)) and an injection mode of introducing a sample trapped in the trap column 40 into the downstream analysis path 2b (see FIG. 2(B)). The switching valve 30 has six ports, and is for switching connection between adjacent ports. In addition to the upstream analysis path 2a and the downstream analysis path 2b, one end of a sample delivery path 32, one end of a drain path 34, and both ends of a trap path 36 are connected to the ports of the switching valve 30. The sample delivery path 32 is a path for delivering a solution containing a sample by a delivery pump 33, and the drain path 34 is a path for discharging liquid externally. The trap column 40 is arranged along the trap path 36.

As shown by a thick line in FIG. 2(A), in the trap mode, the trap path 36 is connected to the downstream side of the sample delivery path 32, and the drain path 34 is connected to a further downstream side. When a solution containing a sample is delivered from the sample delivery path 32 in this state, only the sample component in the solution is trapped in the trap column 40, and other solvents are passed through the trap column 40 to be discharged from the drain path 34. At this time, the upstream analysis path 2a and the downstream analysis path 2b are directly connected.

As shown by a thick line in FIG. 2(B), in the injection mode, the trap path 36 is connected to the downstream side of the upstream analysis path 2a, and the downstream analysis path 2b is connected to a downstream side of the trap path 36. When switching to the injection mode is performed after the sample is trapped in the trap column 40 in the trap mode, a mobile phase from the mobile phase supply device 4 flows to the trap column 40, and the sample component trapped in the trap column 40 is eluted and is led to the analytical column 8 of the downstream analysis path 2b. The sample led to the analytical column 8 is separated into each component, and is detected by the detector 10.

Returning to FIG. 1, the mobile phase supply device 4 includes an aqueous path 12a for delivering an aqueous mobile phase, and an organic solvent path 12b for delivering an organic solvent mobile phase, and the downstream end of the aqueous path 12a and the downstream end of the organic solvent path 12b are both connected to a mixer 27. The upstream end of the analysis path 2 is connected to the mixer 27, and a mixed solution of the aqueous mobile phase and the organic solvent mobile phase is supplied to the analysis path 2 as a mobile phase solvent.

The upstream end of the aqueous path 12a is arranged in a container 14a for storing the aqueous mobile phase, and the aqueous mobile phase is pumped by a delivery pump 16a (a first delivery pump). One end of a split path 22a (a first split path) is connected to a downstream side of the delivery pump 16a along the aqueous path 12a by a joint 20a. The other end of the split path 22a is arranged in the container 14a, and a part of the aqueous mobile phase pumped by the delivery pump 16a is returned to the container 14a. A flowmeter 18a is provided to a further downstream side of the joint 20a, and the flow rate of the aqueous mobile phase being delivered to the mixer 27 is monitored.

The upstream end of the organic solvent path 12b is arranged in a container 14b for storing the organic solvent mobile phase, and the organic solvent mobile phase is pumped by a delivery pump 16b (a second delivery pump). One end of a split path 22b (a second split path) is connected to a downstream side of the delivery pump 16b along the organic solvent path 12b by a joint 20b. The other end of the split path 22b is arranged in the container 14b, and a part of the organic solvent mobile phase pumped by the delivery pump 16b is returned to the container 14b. A flowmeter 18b is provided to a further downstream side of the joint 20b, and the flow rate of the organic solvent mobile phase being delivered to the mixer 27 is monitored.

A flow rate control unit 50 for controlling the flow rate of the aqueous mobile phase and the organic solvent mobile phase delivered to the mixer 27 based on the measurement values of the flowmeters 18a and 18b is provided. The flow rate control unit 50 controls the driving of the delivery pumps 16a and 16b based on the measurement values of the flowmeters 18a and 18b such that the composition of the mobile phase solvent mixed by the mixer 27 becomes a predetermined composition.

A first resistance tube 24 is provided along the aqueous path 12a, near the mixer 27, and a second resistance tube 26 is provided along the organic solvent path 12b, near the mixer 27. Mutual interference between the delivery pumps 16a and 16b is prevented by the installation of the first resistance tube 24 and the second resistance tube 26.

The flow resistance of the second resistance tube 26 is greater than the flow resistance of the first resistance tube 24. Accordingly, instantaneous delivery at a high flow rate of the organic solvent mobile phase, which is less viscous than the aqueous mobile phase, due to a change in the pressure at the time of switching from the trap mode to the injection mode is suppressed.

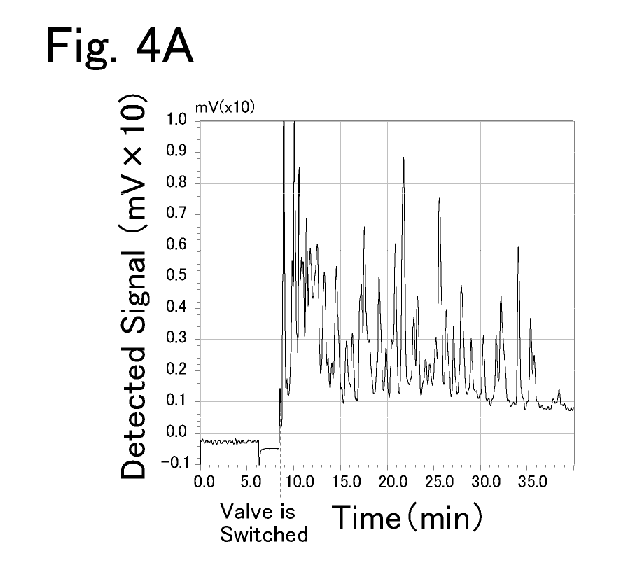

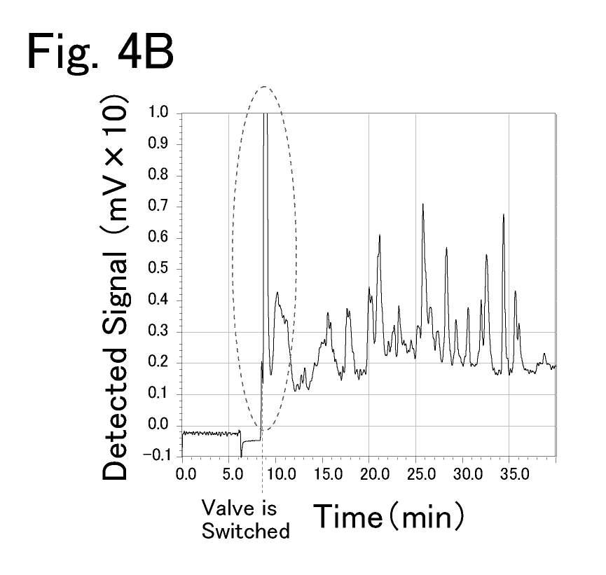

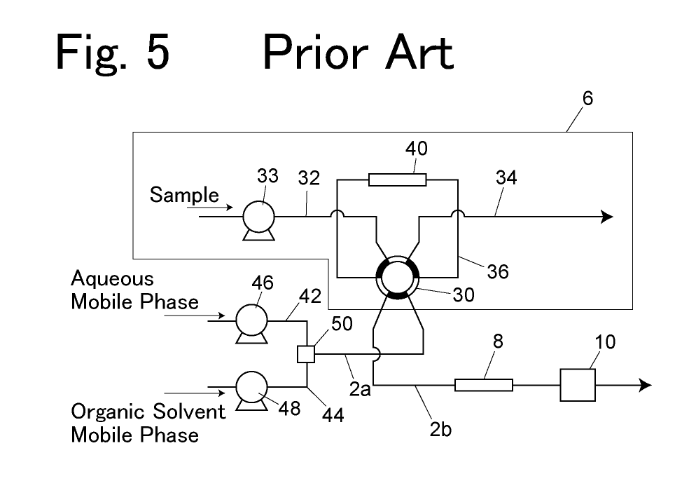

FIG. 3 is a graph showing change over time of a flow rate of the organic solvent mobile phase for a case where the flow resistances of the second resistance tube 26 and the first resistance tube 24 were the same, and for a case where the flow resistance of the second resistance tube 26 was greater than the flow resistance of the first resistance tube 24.

In an example of the case where the flow resistances are the same for the second resistance tube 26 and the first resistance tube 24, both resistance tubes were respectively a resistance tube whose inner diameter is 0.025 mm and whose length is 1000 mm. Here, to make the flow resistances the same is to make the sizes of the resistance tubes the same. However, even if the sizes of the resistance tubes are made the same, the resistance values are different depending on the type of mobile phase that is to flow through, and thus, the resistance value of the first resistance tube 24 through which the aqueous mobile phase flows is, in many cases, greater than the resistance value of the second resistance tube 26 through which the organic solvent mobile phase flows.

In an example of the case where the flow resistance of the second resistance tube 26 is greater than the flow resistance of the first resistance tube 24, the first resistance tube 24 was a resistance tube whose inner diameter is 0.025 mm and whose length is 1000 mm, and the second resistance tube 26 had a resistance tube whose inner diameter is 0.01 mm and whose length is 750 mm serially connected to a resistance tube whose inner diameter is 0.025 mm and whose length is 1000 mm.

Results of delivering at a total flow rate of 600 nL/min, and delivering the aqueous mobile phase at 550 nL/min and a low-viscosity organic solvent mobile phase, such as acetonitrile, at 50 nL/min in the two cases described above are shown in FIG. 3. Here, a flow resistance of about 2 MPa may be reached in the first resistance tube 24, and a flow resistance of about 4 MPa may be reached in the second resistance tube 26 with a greater flow resistance. However, these numerical values are not restrictive because an absolute pressure value is different depending on the type of column or the like to be installed. In the case an aqueous solvent passes through the first resistance tube 24, and the solvent that passes through the second resistance tube 26 is the organic solvent mobile phase, which is less viscous than the aqueous mobile phase, an effect is achieved if the flow resistance of the second resistance tube 26 is greater than that of the first resistance tube 24.

In the graph in FIG. 3, the trap mode is switched to the injection mode after five minutes have passed from the start of acquisition of data. In the case when the flow resistances of the second resistance tube 26 and the first resistance tube 24 were approximately the same, the organic solvent mobile phase was instantaneously delivered at a high flow rate due to the change in the pressure according to the switching, and the disturbance in the flow rate was about 131.4 nL in terms of a flow rate value obtained from the area of the waveform. In contrast, in the case when the flow resistance of the second resistance tube 26 was greater than that of the first resistance tube 24, the flow rate of the organic solvent mobile phase was not greatly disturbed, and the disturbance in the flow rate was about 4.3 nL in terms of a flow rate obtained from the area of the waveform. It can thereby be seen that a sudden and drastic change in the flow rate of the organic solvent mobile phase at the time of switching from the trap mode to the injection mode may be suppressed by making the flow resistance on the side of the organic solvent path 12b greater than the flow resistance on the side of the aqueous path 12a.

Additionally, a resistance tube 28 is provided to the split path 22b to make the split ratio of the organic solvent mobile phase a predetermined ratio. The size of the flow resistance of the resistance tube 28 is determined based on the size of the flow resistance of the resistance tube 26.

1. A mobile phase supply device comprising:
an aqueous path including a first delivery pump for delivering an aqueous mobile phase;
an organic solvent path including a second delivery pump for delivering an organic solvent mobile phase; and
a mixer for mixing mobile phases from the aqueous path and the organic solvent path, and supplying the mixture to an analysis path of a liquid chromatograph.
wherein a flow resistance between the second delivery pump and the mixer is greater than a flow resistance between the first delivery pump and the mixer.

2. The mobile phase supply device according to claim 1,
wherein the aqueous path is split at a downstream side of the first delivery pump into a first path joined to the mixer and a first split path different from the first path, and
wherein the organic solvent path is split at a downstream side of the second delivery pump into a second path joined to the mixer and a second split path different from the second path.

3. The mobile phase supply device according to claim 2, wherein the second path of the organic solvent path includes a path whose inner diameter is smaller than that of the first path of the aqueous path.

4. The mobile phase supply device according to claim 1, wherein a path, of the organic solvent path, joined to the mixer includes a path whose inner diameter is smaller than that of a path, of the aqueous path, joined to the mixer.

5. A liquid chromatograph comprising:
an analysis path including a analytical column for separating a sample, and a detector for detecting a sample component separated by the analytical column;
the mobile phase supply device according to claim 1, being connected to an upstream end of the analysis path and being for supplying, to the analysis path, a mobile phase solvent of a mixed solution of an aqueous mobile phase and an organic solvent mobile phase; and
a sample introduction unit including a sample delivery path for delivering a solution containing a sample, a trap column for temporarily storing the sample, and a switching valve for switching a path to be connected, the sample introduction unit being capable of switching, by switching of the switching valve, to either of a trap mode where the trap column is connected to a downstream side of the sample delivery path and an injection mode where the trap column is connected between the mobile phase supply device and the analytical column.

6. A liquid chromatograph comprising:
an analysis path including a analytical column for separating a sample, and a detector for detecting a sample component separated by the analytical column;
the mobile phase supply device according to claim 2, being connected to an upstream end of the analysis path and being for supplying, to the analysis path, a mobile phase solvent of a mixed solution of an aqueous mobile phase and an organic solvent mobile phase; and
a sample introduction unit including a sample delivery path for delivering a solution containing a sample, a trap column for temporarily storing the sample, and a switching valve for switching a path to be connected, the sample introduction unit being capable of switching, by switching of the switching valve, to either of a trap mode where the trap column is connected to a downstream side of the sample delivery path and an injection mode where the trap column is connected between the mobile phase supply device and the analytical column.

7. A liquid chromatograph comprising:
an analysis path including a analytical column for separating a sample, and a detector for detecting a sample component separated by the analytical column;
the mobile phase supply device according to claim 3, being connected to an upstream end of the analysis path and being for supplying, to the analysis path, a mobile phase solvent of a mixed solution of an aqueous mobile phase and an organic solvent mobile phase; and
a sample introduction unit including a sample delivery path for delivering a solution containing a sample, a trap column for temporarily storing the sample, and a switching valve for switching a path to be connected, the sample introduction unit being capable of switching, by switching of the switching valve, to either of a trap mode where the trap column is connected to a downstream side of the sample delivery path and an injection mode where the trap column is connected between the mobile phase supply device and the analytical column.

8. A liquid chromatograph comprising:
an analysis path including a analytical column for separating a sample, and a detector for detecting a sample component separated by the analytical column;
the mobile phase supply device according to claim 4, being connected to an upstream end of the analysis path and being for supplying, to the analysis path, a mobile phase solvent of a mixed solution of an aqueous mobile phase and an organic solvent mobile phase; and
a sample introduction unit including a sample delivery path for delivering a solution containing a sample, a trap column for temporarily storing the sample, and a switching valve for switching a path to be connected, the sample introduction unit being capable of switching, by switching of the switching valve, to either of a trap mode where the trap column is connected to a downstream side of the sample delivery path and an injection mode where the trap column is connected between the mobile phase supply device and the analytical column
